(19) United States
(12) Patent Application Publication
(10) Pub. No.: US 2024/0328392 A1
(43) Pub. Date: Oct. 3, 2024

(54) METHOD OF DETERMINING FREE-FLOW WIND SPEED FOR A WIND FARM

(71) Applicant: IFP Energies nouvelles, RUEIL-MALMAISON (FR)

(72) Inventor: David COLLET, RUEIL-MALMAISON CEDEX (FR)

(21) Appl. No.: 18/614,798

(22) Filed: Mar. 25, 2024

(30) Foreign Application Priority Data
Mar. 28, 2023 (FR) 2302940

(51) Int. Cl. F03D 17/00

(52) U.S. Cl. CPC F03D 17/006; F03D 17/007; F05B 2200/263; F05B 2260/84; F05B 2270/304; F05B 2270/32; F05B 2270/321; F05B 2270/328

(57) ABSTRACT

The present invention is a method of determining the free-flow wind speed (V_{∞}) for a wind farm, using measurements (MES), a wind farm model (MOD) and an ensemble Kalman filter (KEN).

### CROSS-REFERENCE TO RELATED APPLICATIONS

Reference is made to French Patent Application No. 2302940 filed Mar. 28, 2023, which is incorporated herein by reference in its entirety.

### BACKGROUND OF THE INVENTION

### Field of the Invention

The present invention relates to the field of renewable energies and more particularly to the measurement of the resource of wind turbines, the wind, with wind prediction, wind farm control (orientation, torque and speed regulation) and at least one of diagnosis and monitoring objectives.

A wind farm, also referred to as wind park or wind power plant, is a site comprising wind turbines that produce electricity. This site may be located either onshore or offshore. A distinction is thus made between onshore wind farms and offshore wind farms at sea.

The wind turbines of these farms are generally horizontal-axis turbines provided with a system for orienting the horizontal rotational axis in the direction of the wind, so as to maximize the energy recovered by the turbine. A wind turbine allows the kinetic energy from the wind to be converted into electrical or mechanical energy. For conversion of wind to electrical energy, it is made up of the following elements:
a tower allowing a rotor to be positioned at a sufficient height to enable motion thereof (necessary for horizontal-axis wind turbines) or this rotor to be positioned at a height enabling it to be driven by a stronger and more regular wind than at ground level. The tower generally houses part of the electrical and electronic components (modulator, control, multiplier, generator, etc.),
a nacelle mounted at the top of the tower, housing mechanical, pneumatic and some electrical and electronic components necessary to operate the machine (modulator, control, multiplier, generator, etc.). The nacelle can rotate to orient the rotor in the right direction,
a rotor fastened to the nacelle, comprising blades (generally three) and the hub of the wind turbine. The rotor is driven by the wind energy and it is connected by a mechanical shaft, directly or indirectly (via a gearbox and mechanical shaft system), to an electrical machine (electric generator) that converts the energy recovered to electrical energy. The rotor is potentially provided with control systems such as variable-angle blades or aerodynamic brakes,
optionally a transmission, notably made up of two shafts (mechanical shaft of the rotor and mechanical shaft of the electrical machine) connected by a multiplier (gearbox).

Since the beginning of the 1990s, there has been renewed interest in wind power, in particular in the European Union where the annual growth rate is about 20%. This growth is attributed to the inherent possibility for carbon-emission-free electricity generation. In order to sustain this growth, the energy yield of wind turbines and wind farms still needs to be further improved. The prospect of wind power production increase requires developing effective production tools and advanced control tools in order to improve the performances of the machines and of the wind farms.

For this power regulation, controllers have been designed for variable-speed aerogenerators. The purpose of the controllers is to maximize the electrical power recovered, to minimize the rotor speed fluctuations, and to minimize the fatigue and the extreme moments of the structure (blades, tower and platform).

To optimize control, it is important to know the free-flow wind speed for the wind farm. Various techniques have been developed to that end.

According to a first technique, using an anemometer allows estimation of a wind speed at one point, but this imprecise technology does not enable measuring an entire wind field or knowing the three-dimensional components of the wind speed.

According to a second technique, a LiDAR (Light Detection And Ranging) sensor can be used. LiDAR is a remote sensing or optical measurement technology based on the analysis of the properties of a beam returned to the emitter. This method is notably used for determining the distance to an object by use of a pulse laser. Unlike radars based on a similar principle, LiDAR sensors use visible or infrared light instead of radio waves. The distance to an object or a surface is given by the measurement of the delay between the pulse and the detection of the reflected signal.

In the field of wind turbines, LiDAR sensors are announced as essential for proper functioning of large wind turbines, especially now that their size and power is increasing (today 5 MW, soon 12 MW for offshore turbines). This sensor enables remote wind measurements, first allowing wind turbines to be calibrated so that they can deliver maximum power (power curve optimization). For this calibration stage, the sensor can be positioned on the ground and vertically oriented (profiler), which allows measuring the wind speed and direction, as well as the wind gradient depending on the altitude. This application is particularly critical because it allows knowing the energy generating resource. This is important for wind turbine projects since it conditions the financial viability thereof.

A second application consists in sets the sensor on the nacelle of the wind turbine in order to measure the wind field ahead of the turbine while being nearly horizontally oriented. A priori, measuring the wind field ahead of the turbine allows knowing in advance the turbulence the wind turbine is going to encounter shortly thereafter. However, current wind turbine control and monitoring techniques do not allow accounting for a measurement performed by a LiDAR sensor by estimating precisely the wind speed at the rotor, that is in the rotor plane. Such an application is notably described in patent application FR-3-013,777 (US-2015/145,253).

However, LiDAR sensors are expensive. In addition, development of such a LiDAR sensor being relatively recent, it remains difficult to know, by converting the raw measurements of the LiDAR sensor, how to exploit the wind field characteristics such as wind speed, wind direction, wind shear, turbulence, induction factor, etc. Such a LiDAR sensor therefore requires a complex implementation to determine the wind speed in the rotor plane.

According to a third technique, the free-flow wind speed can be obtained from a real-time control and data acquisition SCADA (Supervisory Control And Data Acquisition) system. A real-time control and data acquisition SCADA system is a large-scale remote control system allowing real-time processing of a large number of remote measurements and remote control of the technical facilities. It is an industrial technology in the field of instrumentation, whose implementations can be considered as instrumentation structures including a middleware type layer. Preferably, all the measurements can be obtained from the SCADA system, which facilitates implementation of the method without any particular instrumentation. For example, patent application FR-3,107,094 (US-2021/0,279,389) concerns determination of the wind in the rotor plane from SCADA data.

However, data obtained by a SCADA system or a LiDAR sensor does not enable direct determination of the free-flow wind speed. This data requires processing to obtain such free-flow wind speed information.

### SUMMARY OF THE INVENTION

The invention determines in real time the free-flow wind speed for a wind farm, in a robust and directly exploitable manner, for example for at least one of control and diagnosis of the wind turbine. The invention therefore relates to a method of determining the free-flow wind speed for a wind farm, using measurements (notably SCADA measurements), a wind farm model and an ensemble Kalman filter. Using an ensemble Kalman filter enables robust real-time determination of the free-flow wind speed.

The invention also relates to a method of controlling a wind farm, and to a wind farm using the method according to the invention.

The invention relates to a method of determining the free-flow wind speed for a wind farm. The following steps are carried out for this method:
a) measuring, for at least one wind turbine of the wind farm, the wind speed in the rotor plane of the turbine, the turbulence intensity in the rotor plane of the turbine, the wind direction in the rotor plane of the turbine, and the power generated by the turbine;
b) constructing a model for the wind farm that connects at least the free-flow wind speed to the wind speed in the rotor plane, to the turbulence intensity in the rotor plane, to the wind direction in the rotor plane and to the power generated by each turbine; and
c) determining the free-flow wind speed for the wind farm by means of an ensemble Kalman filter, notably from uncertainties estimated by Monte Carlo draws, applied to the model of the wind farm, and from the measurements of the wind speed in the rotor plane, of the turbulence intensity in the rotor plane, of the wind direction in the rotor plane and of the generated power.

According to one embodiment, the wind farm model further connects at least one of the free-flow wind direction and the free-flow wind intensity to the wind speed in the rotor plane, turbulence intensity in the rotor plane, wind direction in the rotor plane and generated power, and at least one of a free-flow wind direction and a free-flow wind turbulence are further determined.

According to one implementation, the farm model and a covariance matrix of the ensemble Kalman filter depend on an alignment bias between the north of the wind vane of at least one wind turbine and the theoretical north, and the alignment bias is further determined.

According to one aspect, the output covariance matrix of the ensemble Kalman filter depends on trigonometric functions of the wind direction measured in the rotor plane, preferably by accounting for the covariance between the trigonometric functions.

Advantageously, the error covariance matrix of the ensemble Kalman filter depends on an approximation of trigonometric functions of the free-flow wind direction, preferably by use of a two-dimensional Gaussian centered at the tangent to a unit circle of the wind direction.

According to an embodiment, the free-flow wind speed is determined by carrying out the following steps:
i. initializing k=0, state vector x₀ and a state of the covariance matrix P (0|0);
ii. at any time k different from 0, propagating the uncertainty on the estimation of the state P_{k|k-1}=FₖPₖ₋₁Fₖ^{T}+Qₖ₋₁, with Fₖ being the dynamic model of the state, P_{k|k-1} being the error covariance from the measurements of the time k-1, Pₖ₋₁ being the error variance from the measurements of the time k-1, and Qₖ₋₁ being the covariance matrix of the estimation error on xₖ₋₁;
iii. at any time k different from 0, acquiring the measurements y(k); and
iv. at any time k different from 0, determining the free-flow wind speed by randomly drawing N states \hat{X}_{k|k-1}={\hat{x}_{k,1|k-1}, . . . , \hat{x}_{k,N|k-1}} according to a Gaussian distribution N(x_{k|k-1}, P_{k|k-1}) and by applying the following equations; Kₖ=P_{x,y}Sₖ⁻¹ and

$${\hat{x}}_{k} = {\hat{x}}_{k \vert k - 1} + {K}_{k} {\tilde{y}}_{k}$$

$${P}_{k} = {P}_{k \vert k - 1} - {K}_{k} {S}_{k} {K}_{k}^{T} ,$$

with k being the discrete time, Kₖ being the gain of the ensemble Kalman filter, P_{x,y} being the covariance between the states and the outputs of the wind farm model, Sₖ being the covariance of the prediction error of the model, P_{k|k-1} being the error covariance from the measurements of the time k-1, Pₖ being the error variance from the measurements of the time k, xₖ being the estimation of state x from the measurements of time k, x_{k|k-1} being the estimation of state x from the measurements of time k-1, \tilde{y}ₖ being the difference between measured output yₖ and the output given by the wind farm model from the estimated state at the previous time.

According to an embodiment option, the wind speed in the rotor plane, the turbulence intensity in the rotor plane, the wind direction in the rotor plane and the aerodynamic power are measured (MES), from measurements of the rotational speed of the rotor, the inclination angle of the turbine blades, as well as the power generated by the turbine.

The invention further relates to a method of controlling a wind farm, wherein the following steps are carried out:
a) determining the free-flow wind speed by use of the method according to one of the above features; and
b) controlling the wind farm according to the free-flow wind speed.

Furthermore, the invention relates to a wind farm. At least one wind turbine comprises means for measuring the wind speed in the rotor plane of the turbine, the turbulence intensity in the rotor plane of the turbine, the wind direction in the rotor plane of the turbine, and the power generated by the turbine, and the wind farm comprises means for determining the free-flow wind speed capable of implementing the method according to one of the above features.

According to an embodiment, the wind farm comprises a real-time control and data acquisition system that includes the means for measuring the wind speed in the rotor plane of the turbine, the wind turbulence intensity in the rotor plane, the wind direction in the rotor plane of the turbine, and the power generated by the turbine.

### BRIEF DESCRIPTION OF THE DRAWINGS

Other features and advantages of the method according to the invention will be clear from reading the description hereafter of embodiments given by way of non-limitative example, with reference to the accompanying drawings wherein:

FIG. 1 illustrates the steps of the method according to an embodiment of the invention;

FIG. 2 illustrates, for an example, curves of the wind speed in the rotor plane of the turbines of a wind farm;

FIG. 3 illustrates, for the example of FIG. 2, curves of the wind direction in the rotor plane of the turbines of the wind farm as a function of time;

FIG. 4 illustrates, for the example of FIGS. 2 and 3, curves of the turbulence intensity in the rotor plane of the turbines of the wind farm as a function of time;

FIG. 5 illustrates, for the example of FIGS. 2 to 4, curves of the power generated by each turbine of the wind farm as a function of time;

FIG. 6 illustrates, for the example of FIGS. 2 to 5, curves of the yaw angle of the turbines of the wind farm as a function of time;

FIG. 7 illustrates, for the example of FIGS. 2 to 6, curves of the free-flow wind speed as a function of time, with a reference curve, and two speed curves obtained by two embodiments of the method according to the invention;

FIG. 8 illustrates, for the example of FIGS. 2 to 7, curves of the trigonometric functions of the free-flow wind direction as a function of time, with a reference curve, and two curves obtained by two embodiments of the method according to the invention;

FIG. 9 illustrates, for the example of FIGS. 2 to 8, curves of the free-flow wind turbulence intensity as a function of time, with a reference curve, and two curves obtained by two embodiments of the method according to the invention; and

FIG. 10 illustrates, for the example of FIGS. 2 to 9, curves of the alignment bias of wind vanes of the various turbines of the wind farm, determined by the method according to the invention.

### DETAILED DESCRIPTION OF THE INVENTION

The present invention relates to a method of determining in real time the free-flow wind speed for a wind farm. A wind farm, also referred to as wind park or wind power plant, is a site comprising wind turbines that produce electricity. The free-flow wind speed is the wind speed that would have been encountered on the wind farm site in the absence of wind farm. This free-flow wind speed is useful notably for at least one of wind farm control (orientation, torque and speed regulation), diagnosis, and monitoring.

According to an embodiment of the invention, the method can further determine at least one of a free-flow wind direction and a free-flow wind turbulence intensity. The free-flow wind direction is the wind direction that would have been encountered on the wind farm site in the absence of wind farm. The free-flow wind turbulence intensity is the turbulence intensity that would have been encountered on the wind farm site in the absence of wind farm. These free-flow wind characteristics can also be useful for wind farm control and/or diagnosis and/or monitoring.

The method according to the invention comprises the following steps:
1) Measurement of wind speed, turbulence intensity, wind direction and generated power
2) Construction of a wind farm model
3) Determination of the free-flow wind speed.

Steps 2 and 3 can be carried out by a computer, notably a computer, a processor or a calculator. The steps are detailed in the description hereafter.

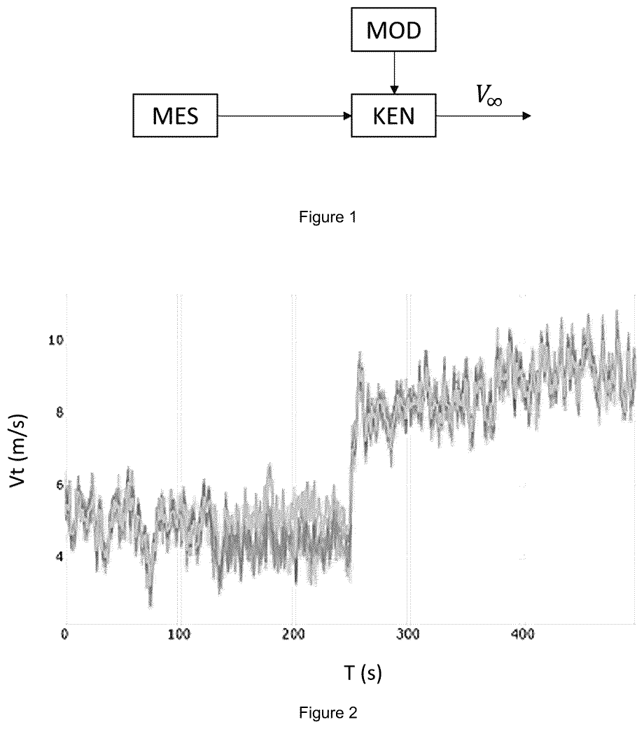

FIG. 1 schematically illustrates, by way of non-limitative example, the steps of the method for determining the free-flow wind speed according to an embodiment of the invention. The wind speed, the turbulence intensity and the wind direction in the rotor plane of at least one wind turbine are measured (MES), as well as the power generated by at least one turbine of the wind farm. A wind farm model (MOD) is constructed. The free-flow wind speed (V_{∞}) is then determined using an ensemble Kalman filter (KEN) applied to the wind farm model (MOD) and to the measurements (MES).

### 1) Measurement of Wind Speed, Turbulence Intensity, Wind Direction and Generated Power

This step consists in measuring, for at least one turbine of the wind farm:
the wind speed in the rotor plane of the turbine,
the wind turbulence intensity in the rotor plane of the turbine,
the wind direction in the rotor plane of the turbine, and
the power generated by the turbine.

Preferably, measurements are performed for all the turbines of the wind farm in order to obtain accurate information in different locations of the wind farm, to increase the accuracy and robustness of the free-flow wind speed determination.

Advantageously, these measurements can be performed directly.

Alternatively, these measurements can be directly derived notably from measurements of:
the rotational speed of the turbine rotor,
the inclination angle of the turbine blades, and
the power generated by the turbine.

According to an embodiment, the wind speed and direction in the rotor plane can be measured, notably using at least one anemometer, and at least one of measurements using at least one real-time control and data acquisition SCADA (Supervisory Control And Data Acquisition) system, or any similar sensor. A real-time control and data acquisition SCADA system is a large-scale remote control system allowing real-time processing of a large number of remote measurements and remote control of technical facilities. It is an industrial technology in the field of instrumentation, whose implementations can be considered as instrumentation structures including a middleware type layer. Besides, the SCADA system accounts for at least another measurement so as to make determination of the wind speed in the rotor plane more accurate. It may notably be temperatures, electrical data, vibrations, etc. The temperatures can provide information on effective mechanical losses, thus allowing modeling of the wind turbine to be refined. Accelerometry, combined with a sufficiently fine and faithful modal and vibratory understanding of the structure, can allow to go back to an estimation of the wind state and of the turbulences impacting the wind turbine.

According to an implementation of the invention, the power generated by the turbine can be measured by a SCADA system.

As a variant, at least one of the measurements can be obtained by a dedicated sensor. For this embodiment:
to measure the rotational speed of the rotor, a rotor angular rotation sensor can be used, and/or
to measure the inclination angle of the blades, an angular blade position sensor can be used, and/or
to measure the power generated by the conversion machine, a known and controlled voltage sensor can be used, and an intensity sensor can be used to measure the output current of the wind turbine generator.

### 2) Construction of a Wind Farm Model

This step constructs a wind farm model. The wind farm model connects the free-flow wind speed to the wind speed in the rotor plane of at least one wind turbine, to the turbulence intensity at the rotor of at least one wind turbine, to the wind direction at the rotor of at least one wind turbine, and to the power generated by at least one wind turbine. In other words, the model has the free-flow wind speed as the input, and as outputs the wind speed in the rotor plane of at least one wind turbine, the turbulence intensity at the rotor of at least one wind turbine, the wind direction in the rotor plane of at least one wind turbine, and the power generated by at least one wind turbine.

For the embodiment wherein at least one of a free-flow wind direction and a free-flow wind turbulence intensity is further determined, the wind farm model has, as additional inputs at least one of the free-flow wind direction and the free-flow wind turbulence intensity.

According to an embodiment of the invention, the wind farm model may also have the following inputs at least one of:
the effective misalignment of each wind turbine, also referred to as yaw angle, and this misalignment can notably be used for wake redirection for wind farm control, and
the induction factor of the rotor of each turbine (the induction factor is a wind deceleration coefficient in the induction zone of the wind turbine).

These additional inputs make it possible for the wind farm model to be really representative of physical phenomena within the wind farm.

According to a non-limitative example, the wind farm model can be written as follows:

$$y = ( \begin{matrix}\overline{V} \\ \overline{P} \\ \overline{θ} \\ \overline{TI}\end{matrix} ) = h ( {U}_{∞} , γ , a , p )$$

with y being the model output, h being a function of the model, V̅ being the wind speed in the rotor plane of each turbine, P̅ being the power generated by each turbine, θ̅ being the wind direction in the rotor plane of each turbine, T̅I̅ being the turbulence intensity in the rotor plane of each turbine, γ being the effective misalignment of each turbine, α being the induction factor of each turbine, p parameters of the model, and U_{∞} being a vector defined by:

$${U}_{∞} = ( \begin{matrix}{V}_{∞} \\ {θ}_{∞} \\ {TI}_{∞}\end{matrix} ) ,$$

with V_{∞} being the free-flow wind speed, θ_{∞} being the free-flow wind direction, TI_{∞} being the free-flow wind turbulence intensity (alternatively, for the embodiment wherein the method only determines the free-flow wind speed, U_{∞} can be written U_{∞}=V_{∞}). Furthermore, as a variant, function h may depend on U_{∞} only.

Function h can be defined as a wind farm engineering model. By way of example, it may be the Floris model developed by NREL (National Renewable Energy Laboratory) or the FarmShadow™ model developed by IFP Energies nouvelles.

### 3) Determination of the Free-Flow Wind Speed

This step determines the free-flow wind speed for the wind farm by use of an ensemble Kalman filter, notably from uncertainties estimated by Monte Carlo draws (in other words, random draws), applied to the model of the wind farm constructed in step 2, and from the measurements obtained in step 1. In other words, the free-flow wind speed is determined by an ensemble Kalman filter that implements the wind farm model and uses the measurements of the wind speed in the rotor plane of at least one wind turbine, the wind direction in the rotor plane of at least one turbine, the power generated by at least one turbine, and the turbulence intensity in the rotor plane of at least one turbine. The Kalman filter is applied to the wind farm model in order to reconstruct the state, here the free-flow wind speed, as a function of the measurements, that is the outputs of the wind farm model.

A Kalman filter is an infinite impulse response filter that estimates the states of a dynamic system from a series of incomplete or noisy measurements. The ensemble Kalman filter (EnKF) is a variant of the Kalman filter suited for high-dimensional problems. The ensemble Kalman filter is a Kalman filter that uses Monte Carlo draws to estimate the Kalman gain, the final goal being to estimate the state of the system by accounting for the uncertainties on the model and the measurements. The idea of an ensemble Kalman filter is to represent the law sought by a sample of the state variable and, as a consequence, the covariance matrix of the Kalman filter becomes a sample covariance matrix. The ensemble Kalman filter is robust because it allows uncertainties to be reduced, and it is easier to implement for non-linear problems than the unscented Kalman filter (UKF).

According to an embodiment of the invention, the free-flow wind speed can be determined by carrying out the following steps:
i. initializing k=0, state vector x₀ and a state of the covariance matrix P(0|0);
ii. at any time k different from 0, propagating the uncertainty on the estimation of the state P_{k|k-1}=FₖPₖ₋₁Fₖ^{T}+Qₖ₋₁, with Fₖ being the dynamic model of the state, P_{k|k-1} being the error covariance from the measurements of the time k-1, Pₖ₋₁ being the error variance from the measurements of the time k-1, and Qₖ₋₁ being the covariance matrix of the estimation error on xₖ₋₁;
iii. at any time k different from 0, acquiring the measurements y(k); and
iv. at any time k different from 0, determining the free-flow wind speed by randomly drawing N states \hat{X}_{k|k-1}={\hat{x}_{k|k-1}, . . . , \hat{x}_{k,N|k-1}} according to a Gaussian distribution N(x_{k|k-1}, P_{k|k-1}) and by applying the following equations; Kₖ=P_{x,y}Sₖ⁻¹ and

$${\hat{x}}_{k} = {\hat{x}}_{k \vert k - 1} + {K}_{k} {\tilde{y}}_{k}$$

$${P}_{k} = {P}_{k \vert k - 1} - {K}_{k} {S}_{k} {K}_{k}^{T} ,$$

with k being the discrete time, Kₖ being the gain of the ensemble Kalman filter, Pry being the covariance between the states and the outputs of the model, Sₖ being the covariance of the prediction error of the model, P_{k|k-1} being the error covariance from the measurements of the time k-1, Pₖ being the error variance from the measurements of the time k, xₖ being the estimation of state x from the measurements of time k, x_{k|k-1} being the estimation of state x from the measurements of time k-1, \tilde{y}ₖ being the difference between measured output yₖ and the output given by the wind farm model from the estimated state at the previous time.

According to an implementation of the invention, a bias in the alignment between the north of the wind vane of each turbine and the theoretical north (also referred to as true north) can further be determined. For this implementation of the invention, the farm model and the covariance matrix of the ensemble Kalman filter depend on the alignment bias. In other words, this bias can be an input of the wind farm model. A wind vane of a turbine is understood to be a sensor allowing determination of the angular orientation of the turbine with respect to the theoretical north. Indeed, in practice, wind direction measurements are often biased due to such an offset between the north of the wind vane and the theoretical north. Taking the bias into account in the covariance matrix enables robust determination of the free-flow wind speed, even in case of misalignment of the wind vanes of the wind farm turbines.

According to an embodiment of the invention, the output covariance matrix of the ensemble Kalman filter can depend on trigonometric functions of the measured wind direction. In the present case, the trigonometric functions can be the cosine and sine functions of the measured wind direction in the rotor plane of the wind turbines. It is thus possible to overcome wind direction measurement periodicity problems likely to blow up the covariance estimations. Preferably, for this embodiment, the covariance between the trigonometric functions can be taken into account, given that the cosine and sine functions are dependent. Thus, the performances of the ensemble Kalman filter can be improved.

According to an embodiment option, the covariance matrix of the ensemble Kalman filter error can depend on an approximation of trigonometric functions of the free-flow wind direction. In the present case, the trigonometric functions can be the cosine and sine functions of the free-flow wind direction. This approximation is useful notably when the direction of the free-flow wind speed is close to 0°. Preferably, for this embodiment, the covariance matrix of the ensemble Kalman filter error can be determined by use of a two-dimensional Gaussian centered at the tangent to a unit circle of the free-flow wind direction. Thus, possible output covariance matrix inversion problems can be avoided. In the rest of the description, this embodiment option is referred to as trigonometric method, and the embodiments that do not implement this option are referred to as direct method.

In the rest of the description, various embodiments of the ensemble Kalman filter applied to the method according to the invention are illustrated by way of non-limitative example.

The dynamic equation of the following system can be considered:

$${x}_{k} = {F}_{k} {x}_{k - 1} + {v}_{k - 1}$$

with k being the discrete time, xx being the state of the system at time k, xₖ₋₁ being the state of the system at time k-1, Fₖ being the matrix of the system dynamics at time k, vₖ₋₁ being the state prediction error at time k-1, with vₖ being a Gaussian distribution defined by vₖ˜ [symbol] (0, Qₖ), with Qₖ being the covariance matrix of the estimation error on xₖ.

The uncertainty Pk accumulated in the process can be propagated at time k as follows:

$${P}_{k \vert k - 1} = {F}_{k} {P}_{k - 1} {F}_{k}^{T} + {Q}_{k - 1}$$

Covariance matrix P_{k|k-1} gives an idea of the uncertainty on the predicted state \hat{x}_{k|k-1} from the estimated state at time k-1. The distribution of xk is a Gaussian distribution such that xₖ˜ [symbol] (\hat{x}_{k|k-1}, P_{k|k-1}).

To calculate the Kalman gain used to weight the knowledge of the state estimated by the model and the measurement, it is possible to randomly draw N states from \hat{X}_{k|k-1}={\hat{x}_{k,1|k-1}, . . . , \hat{x}_{k,N|k-1}} according to the distribution of xₖ˜N(\hat{x}_{k|k-1}, P_{k|k-1}).

The system has a non-linear output equation that can be written as follows:

$${y}_{k} = h ( {x}_{k} , {u}_{k} ) + {ε}_{k}$$

with yₖ being the output of the system at time k, uₖ being the input exogenous (external) to the system at time k, and εₖ being the error at time k, the error being a Gaussian distribution of the form εₖ˜ [symbol] (0, Rₖ), where Rx is the covariance of the uncertainty on the output.

The output equation is applied to each state \hat{X}_{k|k-1}={\hat{x}_{k,1|k-1}, . . . , \hat{x}_{k,N|k-1}}, assuming that uₖ is known, so as to obtain N outputs Ŷ_{k|k-1}={ŷ_{k|k-1,1}, . . . , ŷ_{k|k-1,N}}. The output equation is also used to estimate ŷ_{k|k-1} from \hat{x}_{k|k-1}. The measurement obtained at time k is denoted by yk.

Let Sₖ be the covariance of the prediction error of the model from an uncertain predicted state, so that:

$${y}_{k} ∼ 𝒩 ( {\hat{y}}_{k \vert k - 1} , {S}_{k} )$$

$${S}_{k} = cov ( {\hat{Y}}_{k} - {\hat{y}}_{k \vert k - 1} ) + {R}_{k}$$

with Rₖ being the prediction error of the model without uncertainty on the state of the system, such that yₖ˜ [symbol] (ŷₖ, Rₖ), with ŷₖ being the output of the model with the known state of xₖ.

Let P_{x,y} be the covariance between the randomly drawn states \hat{X}_{k|k-1} and the outputs of the corresponding model Ŷ_{k|k-1}.

$${P}_{x , y} = cov ( {\hat{X}}_{k \vert k - 1} , {\hat{Y}}_{k \vert k - 1} )$$

\tilde{y}ₖ being the difference between measured output yₖ and the output given by the model from the estimated state at the previous time ŷ_{k|k-1}.

The Kalman gain denoted by Kₖ is a ratio between the covariance of the predicted state and the output, knowing the previous state P_{x,y}, and the covariance of the output, knowing the previous state Sₖ.

Kₖ=P_{x,y}Sₖ⁻¹

The Kalman gain allows predicting state \tilde{x}ₖ and to update the covariance matrix of the uncertainty on predicted state Pk such that xₖ˜ [symbol] (\hat{x}ₖ, Pₖ), and

$${\hat{x}}_{k} = {\hat{x}}_{k \vert k - 1} + {K}_{k} {\tilde{y}}_{k}$$

$${P}_{k} = {P}_{k \vert k - 1} - {K}_{k} {S}_{k} {K}_{k}^{T}$$

To improve the performances of the ensemble Kalman filter, the following hyperparameters can be adjusted: the number N of states drawn in the Monte Carlo draw, as well as the covariance matrices of the uncertainty on the dynamic model and the output model, Qₖ and Rₖ.

For the embodiment of the direct method, the steps described below by way of example can be carried out.

For this direct method, state vector xx can be considered constant and uncertain, such that:

$${x}_{k} = ( \begin{matrix}{V}_{∞ , k} \\ {θ}_{∞ , k} \\ log {TI}_{∞ , k}\end{matrix} ) = {I}_{3} {\underbrace{( \begin{matrix}{V}_{∞ , k - 1} \\ {θ}_{∞ , k - 1} \\ log {TI}_{∞ , k - 1}\end{matrix} )}}_{{x}_{k - 1}} + {v}_{k - 1}$$

with V_{∞,k} being the free-flow wind speed at time k, θ_{∞,k} being the free-flow wind direction at time k, TI_{∞,k} being the free-flow wind turbulence intensity at time k, l₃ being the three-dimensional identity matrix, and vₖ₋₁ the element of uncertainty of the free-flow wind that allows evolution of the free-flow wind over time. For this embodiment, log TI_{∞,k} can be considered because the distribution of TI_{∞} is of log-normal, Rayleigh or Poisson type, while being strictly positive.

In this case, covariance matrix Qₖ can be taken diagonal and time-constant, such that:

$${Q}_{k} = diag ( [ {ε}_{V} , {ε}_{θ} , {ε}_{TI} ] )$$

with ε_{V}, ε_{θ}, ε_{TI} being predetermined positive parameters.

For the embodiment variant wherein the trigonometric functions of the free-flow wind direction are taken into account, the model output can be written as follows:

$${y}_{k} = {( \begin{matrix}\overline{V} & \overline{P} & cos \overline{θ} & sin \overline{θ} & \overline{TI}\end{matrix} )}^{T}$$

Considering that all the outputs are independent, covariance matrix Rₖ can be a diagonal and time-constant matrix that is written as:

$${R}_{k} = ( \begin{matrix}{ε}_{\overline{V}} {I}_{{n}_{turbines}} & 0 & 0 & 0 \\ 0 & {ε}_{\overline{p}} {I}_{{n}_{turbines}} & 0 & 0 \\ 0 & 0 & {ε}_{\overline{θ}} {I}_{2 {n}_{turbines}} & 0 \\ 0 & 0 & 0 & {ε}_{\overline{TI}}\end{matrix} )$$

with n_{turbines} being the number of turbines in the wind farm, ln_{turbines} being the identity matrix of dimension n_{turbines}, ε_{V̅}, ε_{θ̅}, ε_{T̅I̅} and ε_{p̅} are positive parameters predetermined according to the measurement quality.

Alternatively, a matrix Rₖ taking the covariances between cos θ̅ and sin θ̅ into account can be determined in order to improve the performances of the ensemble Kalman filter.

For the embodiment of the trigonometric method, the steps described below by way of example can be carried out.

The free-flow wind direction is therefore estimated with the estimation of trigonometric functions of the free-flow wind direction.

In this case, a first-order series expansion can be performed of the cosines and sines of the free-flow wind direction about the free-flow wind direction:

$${θ}_{∞ , k} = {θ}_{∞} + {v}_{θ , k}$$

$$\begin{matrix}cos {θ}_{∞ , k} = cos ( {θ}_{∞} + {v}_{θ , k} ) \\ = cos {θ}_{∞} cos {v}_{θ , k} - sin {θ}_{∞} sin {v}_{θ , k} \\ ≃ cos {θ}_{∞} - sin {θ}_{∞} {v}_{θ , k}\end{matrix}$$

$$\begin{matrix}sin {θ}_{∞ , k} = sin ( {θ}_{∞} + {v}_{θ , k} ) \\ = sin {θ}_{∞} cos {v}_{θ , k} + cos {θ}_{∞} sin {v}_{θ , k} \\ ≃ sin {θ}_{∞} + cos {θ}_{∞} {v}_{θ , k}\end{matrix}$$

The covariance of (cos θ_{∞,k}, sin θ_{∞,k})^{T} can be calculated which is written as a covariance matrix Qₖ as follows:

$${Q}_{k} = ( \begin{matrix}{ε}_{V} & 0 & 0 & 0 \\ 0 & {sin}^{2} {θ}_{∞ , k} {ε}_{θ} & - sin {θ}_{∞ , k} cos {θ}_{∞ , k} {ε}_{θ} & 0 \\ 0 & - sin {θ}_{∞ , k} cos {θ}_{∞ , k} {ε}_{θ} & {cos}^{2} {θ}_{∞ , k} {ε}_{θ} & 0 \\ 0 & 0 & 0 & {ε}_{TI}\end{matrix} )$$

and the dynamic equation of the system can be written:

$${x}_{k} = ( \begin{matrix}{V}_{∞ , k} \\ cos {θ}_{∞ , k} \\ sin {θ}_{∞ , k} \\ log {TI}_{∞ , k}\end{matrix} ) = {I}_{4} {\underbrace{( \begin{matrix}{V}_{∞ , k - 1} \\ cos {θ}_{∞ , k - 1} \\ sin {θ}_{∞ , k - 1} \\ log {TI}_{∞ , k - 1}\end{matrix} )}}_{{x}_{k - 1}} + {v}_{k - 1}$$

with l₄ the four-dimensional identity matrix and vₖ₋₁∈ [symbol] ⁴˜ [symbol] (0, Qₖ₋₁).

Advantageously, the covariance of the cosine and sine of the free-flow wind direction can be a two-dimensional Gaussian centered at the tangent to the unit circle formed by the free-flow wind direction at time k. The following rotation matrix P can therefore be considered:

$$P ( {θ}_{∞ , k} ) = ( \begin{matrix}sin {θ}_{∞ , k} & - cos {θ}_{∞ , k} \\ cos {θ}_{∞ , k} & sin {θ}_{∞ , k}\end{matrix} )$$

and the covariance of (cos θ_{∞,k}, sin θ_{∞,k})^{T} then becomes:

$$cov ( ( cos {θ}_{∞ , k} , sin {θ}_{∞ , k} ) ) = {P ( {θ}_{∞ , k} )}^{T} diag ( ( {ε}_{θ} , {λε}_{θ} ) ) P ( {θ}_{∞ , k} )$$

with λ<<1 a coefficient allowing to stretch the Gaussian and to control the conditioning of the covariance matrix. It is also possible to use this technique in order to have a better estimation of the covariance between cos θ̅ and sin θ̅ in matrix Rₖ.

For the embodiment wherein the wind direction measurements at the rotor are biased by a misalignment of the wind vane of the turbine with respect to the theoretical north, an extended state \tilde{x}ₖ can be defined as the concatenation of xₖ and of a vector, [β₁, . . . , βₙ_{_{turbines}}]^{T}, with βi being the bias on the measurement of the wind direction of turbine i.

The covariance matrix of the dynamic equation of state for the extended state is denoted by \tilde{Q}ₖ and it can be written as follows:

$${\tilde{Q}}_{k} = ( \begin{matrix}{Q}_{k} & 0 \\ 0 & {ε}_{β} {I}_{{n}_{turbines}}\end{matrix} )$$

and the dynamic equation can be written:

$${\tilde{x}}_{k} = {I}_{n} {\tilde{x}}_{k - 1} + {\tilde{v}}_{k - 1}$$

with \tilde{v}ₖ∈ [symbol] ⁿ˜ [symbol] (0, \hat{Q}ₖ), In the identity matrix of dimension n, n is the dimension of vector \tilde{x}ₖ.

Furthermore, for the output equation, bias Bi is added to the yaw angle of each wind turbine.

The various implementations described above allow determination of the state vector xₖ comprising free-flow wind characteristics, including the free-flow wind speed. According to state vector x, the free-flow wind speed can be readily extracted therefrom.

For example, if state vector x is written:

$${x}_{k} = ( \begin{matrix}{V}_{∞ , k} \\ {θ}_{∞ , k} \\ log {TI}_{∞ , k}\end{matrix} )$$

the free-flow wind speed at time k can be determined by use of the equation:

$${V}_{∞ , k} = ( \begin{matrix}1 & 0 & 0\end{matrix} ) {x}_{k}$$

Similarly, the free-flow wind direction at time k can be (optionally) determined by means of the equation:

$${θ}_{∞ , k} = ( \begin{matrix}0 & 1 & 0\end{matrix} ) {x}_{k}$$

and the free-flow wind turbulence intensity at time k can be (optionally) determined by means of the equation:

$$log {TI}_{∞ , k} = ( \begin{matrix}0 & 0 & 1\end{matrix} ) {x}_{k}$$

The present invention also relates to a method of controlling a wind farm. The following steps are carried out for this method:
determining the free-flow wind speed by means of the method for determining the free-flow wind speed according to any one of the variants described above, and
controlling the wind farm according to the free-flow wind speed.

Accurate real-time knowledge of the free-flow wind speed allows suitable wind farm control in terms of minimization of the effects on the turbine structure and maximization of the recovered power. Indeed, through this control, the method allows reducing the loads on the structure, whose blades and tower represent 54% of the cost. Using the method according to the invention therefore allows optimizing the wind turbine structure and thus reducing the costs and maintenance.

According to an implementation of the invention, the inclination angle of at least one of the blades of each turbine of the wind farm, the electrical recovery torque of the generator of each turbine of the wind farm, and the yaw angle of each turbine of the wind farm can be controlled according to the free-flow wind speed. Other types of regulation devices can be used.

The present invention also relates to a method for at least one of monitoring and diagnosis of a wind farm. The following steps can be carried out for this method:
determining the free-flow wind speed by use of the method for determining the wind speed according to any one of the variants or variant combinations described above, and
at least one of monitoring and diagnosing the wind farm operation according to the free-flow wind speed.

At least one of monitoring and diagnosis can for example concern the mechanical stress undergone by the structure of each wind turbine according to the free-flow wind speed.

Furthermore, the invention relates to a computer program product comprising code instructions designed to carry out the steps of one of the methods described above (method of determining the free-flow wind speed, control method, monitoring and diagnosis method). The program is executed on at least one of a wind farm control and diagnosis unit.

The invention also relates to a wind farm, notably an offshore (at sea) or an onshore (on land) wind farm. At least one turbine of the wind farm is equipped with means for measuring the wind speed in the rotor plane, the wind direction in the rotor plane, the turbulence intensity at the rotor, and with means for measuring the power generated by the conversion machine. In addition, the wind turbine comprises means for determining the free-flow wind speed capable of implementing the free-flow wind determination method according to one of the variants or variant combinations described above.

According to an embodiment of the invention, at least one wind turbine can comprise a real-time control and data acquisition system (SCADA) provided with at least one measuring means from among the means for measuring the rotor rotation, the means for measuring the blade inclination angle and the means for measuring the power generated by the conversion machine. Preferably, the SCADA system can be provided with all these measuring means. Moreover, the SCADA system can comprise additional measuring means (temperature measurements, electrical measurements, . . . , for example) allowing determination of the wind speed in the rotor plane to be made more accurate.

Alternatively, at least one wind turbine can comprise at least one sensor for performing at least one of these measurements, such as:
at least one of for measurement of the rotational speed of the rotor, a rotor angular rotation sensor, and at least one of
for measurement of the inclination angle of the blades, an angular blade position sensor, and at least one of
for measurement of the power generated by the conversion machine, a known and controlled voltage sensor, and an intensity sensor to measure the output current of the generator.

For an embodiment of the control method, the wind farm can comprise control means, for example for control of the inclination angle (or pitch angle) of at least one blade of the wind turbine, or for control of the electrical torque, or control of the yaw angle of each turbine, for implementing the control method according to the invention.

It is clear that the invention is not limited to the embodiments of the methods described above by way of example, and that it encompasses any variant embodiment.

### Example

The features and advantages of the method according to the invention will be clear from reading the application example hereafter.

For this example, a wind farm is considered comprising seven quasi-aligned wind turbines (generating a strong wake effect). The turbines of this farm have an 82-m-diameter rotor and a nominal power of 2 MW. Furthermore, measurements are acquired by SCADA data of the wind farm.

FIG. 2 illustrates, for this example, the curves of the wind speed measured in the rotor plane of each turbine Vt in m/s as a function of time T in s. This graph shows the quasi-superimposed curves for the seven wind turbines of the farm.

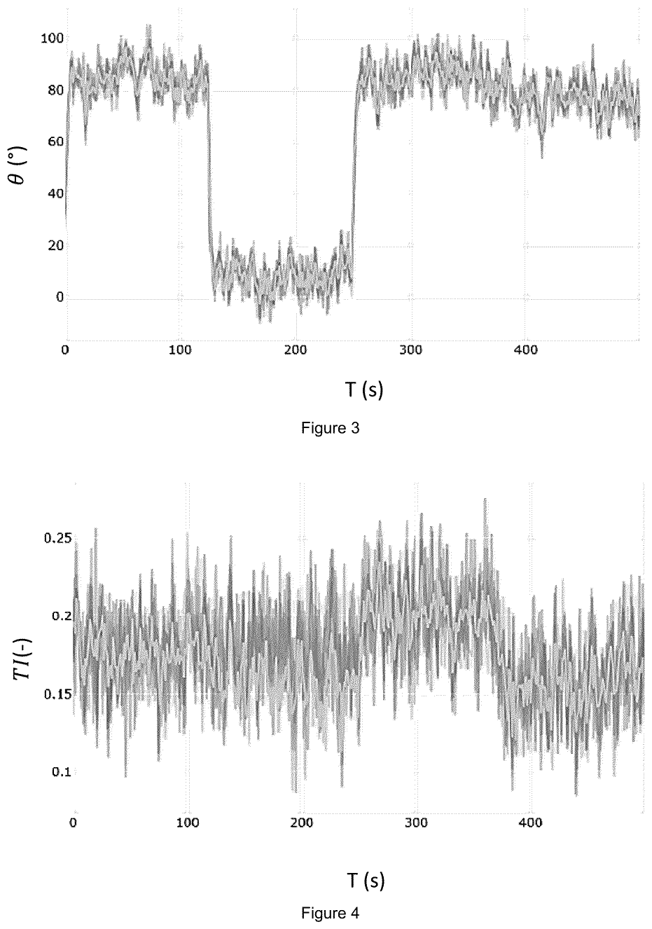

FIG. 3 illustrates, for this example, the curves of the wind direction measured in the rotor plane of each turbine θ in ° as a function of time T in s. This graph shows the quasi-superimposed curves for the seven wind turbines of the farm.

FIG. 4 illustrates, for this example, the curves of the turbulence intensity in the rotor plane of each turbine TI as a function of time T in s. This graph shows the quasi-superimposed curves for the seven wind turbines of the farm.

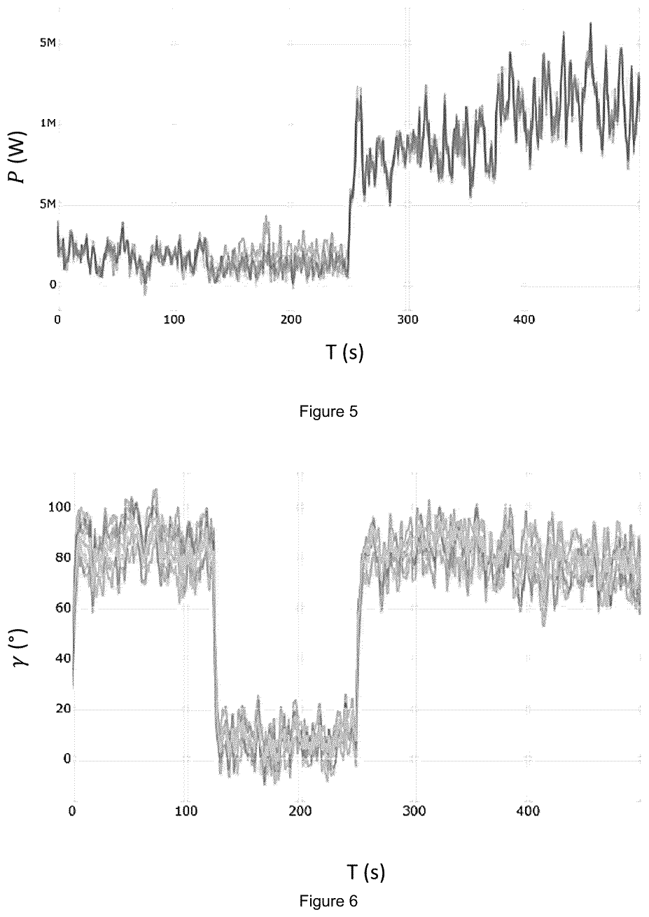

FIG. 5 illustrates, for this example, the curves of the generated power measured for each turbine P in W as a function of time T in s. This graph shows the quasi-superimposed curves for the seven wind turbines of the farm.

FIG. 6 illustrates, for this example, the curves of the yaw angle measured for each turbine γ as a function of time T in s. This graph shows the curves in identical value ranges for the seven wind turbines of the farm.

No alignment bias is first considered for the wind vane of each turbine with respect to the theoretical north. From these measurements, an embodiment of the invention is applied with a direct method, and an embodiment is applied with a trigonometric method.

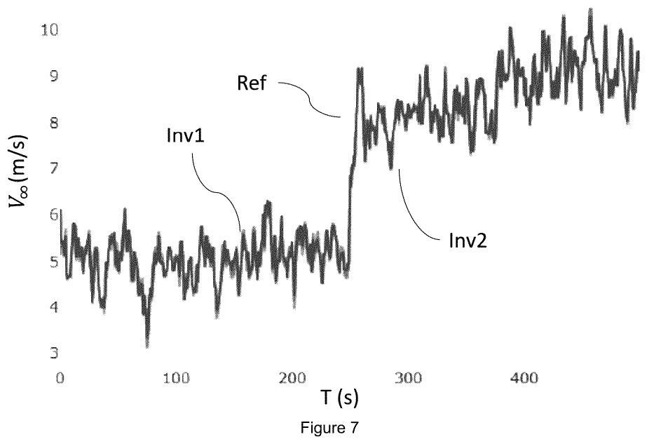

FIG. 7 illustrates, for this example, curves of the free-flow wind speed V_{∞} in m/s as a function of time T in s. The curves shown are the reference free-flow wind speed curve Ref, the free-flow wind speed curve obtained with the direct method Inv1 of the method according to the invention, and the free-flow wind speed curve obtained with the trigonometric method Inv2 of the method according to the invention. It is noted that the curves are superimposed. Thus, the method according to the invention enables accurate determination of the free-flow wind speed.

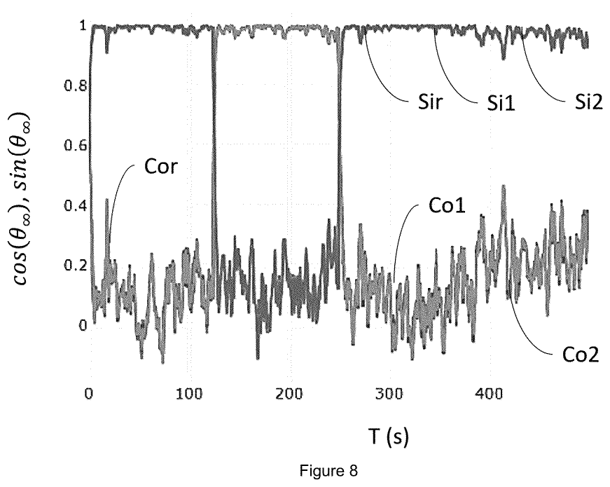

FIG. 8 illustrates, for this example, curves of the cosine and sine of the free-flow wind direction cos(θ_{∞}), sin (θ_{∞}). The curves starting with Co correspond to the cosines and the curves starting with Si correspond to the sines. The curves ending with r correspond to the reference, the curves ending with 1 are those obtained by the direct method according to the invention, and the curves ending with 2 are those obtained with the trigonometric method according to the invention. It is noted that the curves are superimposed. Thus, the method according to the invention enables accurate determination of the free-flow wind direction.

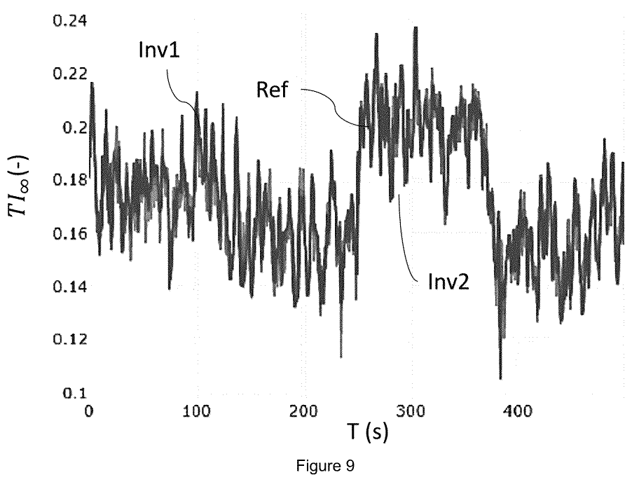

FIG. 9 illustrates, for this example, curves of the free-flow wind turbulence intensity TI_{∞} as a function of time T in s. The curves shown are the reference free-flow wind turbulence intensity curve Ref, the free-flow wind turbulence intensity curve obtained with the direct method Inv1 of the method according to the invention, and the free-flow wind turbulence intensity curve obtained with the trigonometric method Inv2 of the method according to the invention. It is noted that the curves are superimposed. Thus, the method according to the invention enables accurate determination of the free-flow wind turbulence intensity.

An alignment bias of the wind vane of each turbine with respect to the theoretical north is subsequently considered. From these measurements, an embodiment of the invention is applied with a direct method, and with bias determination (i.e. the bias is an input of the wind farm model).

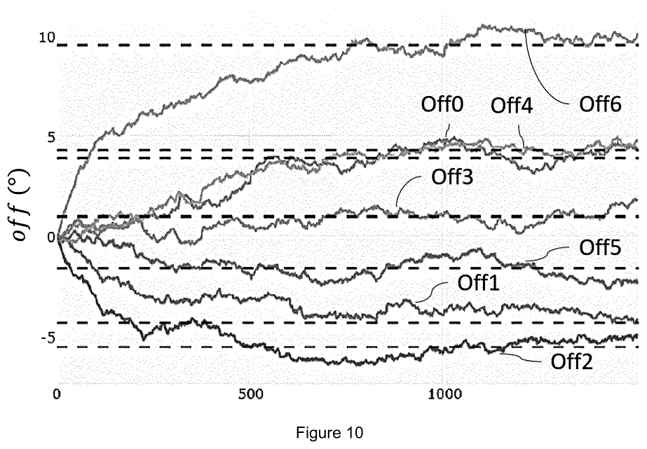

FIG. 10 illustrates, for this example, the bias Off in ° as a function of time T in s. In this figure, the reference biases are indicated by dotted lines. Furthermore, the biases Off1 to Off7 of the seven turbines of the farm obtained by the method according to the invention are shown. It is noted that the method according to the invention enables good estimation of the bias of each turbine.

1-10. (canceled)

11. A method for determining free-flow wind speed for a wind farm, comprising:
a) measuring, for at least one wind turbine of the wind farm, a wind speed in a rotor plane of the at least one turbine, a turbulence intensity in the rotor plane of the at least one turbine, a wind direction in the rotor plane of the at least one turbine, and the power generated by the at least one turbine;
b) constructing a model for the wind farm connecting at least the free-flow wind speed to the wind speed in the rotor plane of the at least one turbine, to the turbulence intensity in the rotor plane of the at least one turbine to the wind direction in the rotor plane of the at least one turbine and to power generated by the at least one turbine; and
c) determining the free-flow wind speed for the wind farm by use of an ensemble Kalman filter from uncertainties estimated by Monte Carlo draws, applied to the model of the wind farm, and from the measurements of the wind speed in the rotor plane of the at least one turbine, of the turbulence intensity in the rotor plane of the at least one turbine, of the wind direction in the rotor plane of the at least one turbine and of the generated power of the at least one turbine.

12. A method as claimed in claim 11, comprising the wind farm model connects at least one of the free-flow wind direction and the free-flow wind intensity to the wind speed in the rotor plane, turbulence intensity in the rotor plane, wind direction in the rotor plane to the generated power, and further comprises determining a free-flow wind direction of the wind farm and a free-flow wind turbulence intensity.

13. A method as claimed in claim 11, wherein the model of the wind farm and a covariance matrix of the ensemble Kalman filter depend on an alignment bias between a north direction of the wind vane of the at least one wind turbine and a theoretical north direction, and further comprises determining the alignment bias.

14. A method as claimed in claim 12, wherein the model of the wind farm and a covariance matrix of the ensemble Kalman filter depend on an alignment bias between a north direction of the wind vane of the at least one wind turbine and a theoretical north direction, and further comprises determining the alignment bias.

15. A method as claimed in claim 11, wherein an output covariance matrix of the ensemble Kalman filter depends on trigonometric functions of the wind direction measured in the rotor plane of the at least one turbine which accounts for covariance between the trigonometric functions.

16. A method as claimed in claim 12, wherein an output covariance matrix of the ensemble Kalman filter depends on trigonometric functions of the wind direction measured in the rotor plane of the at least one turbine which accounts for covariance between the trigonometric functions.

17. A method as claimed in claim 13, wherein an output covariance matrix of the ensemble Kalman filter depends on trigonometric functions of the wind direction measured in the rotor plane of the at least one turbine which accounts for covariance between the trigonometric functions.

18. A method as claimed in claim 14, wherein an output covariance matrix of the ensemble Kalman filter depends on trigonometric functions of the wind direction measured in the rotor plane of the at least one turbine which accounts for covariance between the trigonometric functions.

19. A method as claimed in claim 11, wherein an error covariance matrix of the ensemble Kalman filter depends on an approximation of the trigonometric functions of the free-flow wind direction by using a two-dimensional Gaussian centered at a tangent to a unit circle of the wind direction.

20. A method as claimed in claim 11, wherein the free-flow wind speed is determined by steps of:
i. initializing k=0, state vector x₀ and a state of a covariance matrix P(0|0);
ii. at any time k different from 0, propagating an uncertainty on an estimation of the state P_{k|k-1}=FₖPₖ₋₁Fₖ^{T}+Qₖ₋₁, with Fₖ being the dynamic model of the state, P_{k|k-1} being the error covariance from the measurements of the time k-1, Pₖ₋₁ being the error variance from the measurements of the time k-1, and Qk-1 being the covariance matrix of the estimation error on xₖ₋₁;
iii. at any time k different from 0, acquiring the measurements y(k); and
iv. at any time k different from 0, determining the free-flow wind speed by randomly drawing N states \hat{X}_{k|k-1}={\hat{x}_{k,1|k-1}, . . . , \hat{x}_{k,N|k-1}} according to a Gaussian distribution [symbol] (x_{k|k-1}, P_{k|k-1}) and by applying equations of: Kₖ=P_{x,y}Sₖ⁻¹ and
$${\hat{x}}_{k} = {\hat{x}}_{k \vert k - 1} + {K}_{k} {\tilde{y}}_{k}$$
$${P}_{k} = {P}_{k \vert k - 1} - {K}_{k} {S}_{k} {K}_{k}^{T} ,$$
with k being the discrete time, Kₖ being the gain of the ensemble Kalman filter, P_{x,y} being the covariance between the states and outputs of the wind farm model, Sₖ being a covariance of the prediction error of the model, P_{k|k-1} being an error covariance from the measurements of the time k-1, Pₖ being an error variance from the measurements of the time k, xₖ being an estimation of state x from the measurements of time k, x_{k|k-1} being an estimation of state x from the measurements of time k-1, \tilde{y}ₖ being a difference between measured output yₖ and an output given by the wind farm model from the estimated state at the previous time.

21. A method as claimed in claim 11, wherein the wind speed in the rotor plane, the turbulence intensity in the rotor plane of the at least one turbine, the wind direction in the rotor plane of the at least one turbine and aerodynamic power are measured, from measurements of the rotational speed of the rotor of the at least one turbine, the inclination angle of the turbine blades, and power generated by the turbine.

22. A method of controlling a wind farm, comprising:
a) determining the free-flow wind speed by using the method according to claim 11; and
b) controlling the wind farm according to the determined free-flow wind speed.

23. A method of controlling a wind farm, comprising:
a) determining the free-flow wind speed by using the method according to claim 12; and
b) controlling the wind farm according to the determined free-flow wind speed.

24. A method of controlling a wind farm, comprising:
a) determining the free-flow wind speed by using the method according to claim 13; and
b) controlling the wind farm according to the determined free-flow wind speed.

25. A method of controlling a wind farm, comprising:
a) determining the free-flow wind speed by using the method according to claim 14; and
b) controlling the wind farm according to the determined free-flow wind speed.

26. A method of controlling a wind farm, comprising:
a) determining the free-flow wind speed by using the method according to claim 16; and
b) controlling the wind farm according to the determined free-flow wind speed.

27. A method of controlling a wind farm, comprising:
a) determining a free-flow wind speed by using the method according to claim 17; and
b) controlling the wind farm according to the determined free-flow wind speed.

28. A method of controlling a wind farm, comprising:
a) determining a free-flow wind speed by using the method according to claim 18; and
b) controlling the wind farm according to the determined free-flow wind speed.

29. A wind farm including at least one wind turbine comprising means for measuring the wind speed in a rotor plane of the at least one turbine, the turbulence intensity in a rotor plane of the at least one turbine, the wind direction in the rotor plane of the at least one turbine, and the power generated by the at least one turbine, and the wind farm comprises means for determining free-flow wind speed for implementing the method according to claim 11.

30. A wind farm as claimed in claim 29, comprising a real-time control and data acquisition system including means for measuring the wind speed in the rotor plane of the at least one turbine, the wind turbulence intensity in the rotor plane of the at least one turbine, the wind direction in the rotor plane of the at least one turbine, and the power generated by the at least one turbine.
